(19) United States
(12) Patent Application Publication
(10) Pub. No.: US 2016/0050251 A1
(43) Pub. Date: Feb. 18, 2016

(54) Mobile Web-Based Interpreter

(71) Applicant: Vertical Computer Systems, Inc., Richardson, TX (US)

(72) Inventors: Luiz Claudio Valdetaro, Coppell, TX (US); Harold Frazier, JR., Allen, TX (US)

(73) Assignee: VERTICAL COMPUTER SYSTEMS, INC., Richardson, TX (US)

(21) Appl. No.: 14/632,893

(22) Filed: Feb. 26, 2015

Related U.S. Application Data
(63) Continuation-in-part of application No. 13/491,372, filed on Jun. 7, 2012.
Application No. 13/491,372 is a continuation-in-part of application No. 12/966,741, filed on Dec. 13, 2010, now Pat. No. 9,112,832.
(60) Provisional application No. 61/945,024, filed on Feb. 26, 2014.

(51) Int. Cl. H04L 29/08; H04W 80/04; G06F 9/445

(52) U.S. Cl. CPC H04L 67/02; G06F 9/44584; H04W 80/04

(57) ABSTRACT

A Mobile Internet Device (“MID”) includes an operating system and a framework. The operating system includes a first web server configured for use at the operating system level, wherein the first web server includes a script interpreter and is connectable to an Internet browser via the Internet for receiving requests from the browser. The framework includes a second web server configured to operate at the framework level and adapted for communication with the first web server, wherein the second web server further includes methods dedicated to encapsulating framework functions.

### CROSS-REFERENCE TO RELATED APPLICATIONS

This application claims the benefit of Application No. 61/945,024, filed Feb. 26, 2014, and is a continuation-in-part (CIP) application of prior application Ser. No. 13/491,372, filed Jun. 7, 2012, which is a CIP of application Ser.No. 12/966,741, filed Dec. 13, 2010, which claims the benefit of Application No. 61/494,407, filed Jun. 7, 2011, all of which applications are hereby incorporated herein by reference, in their entirety.

### TECHNICAL FIELD

The invention relates generally to web-based server applications running on a Mobile Internet Device (MID).

### BACKGROUND

Mobile Internet Devices (“MIDs”, such as Android® devices) running mobile web servers usually use operating systems with frameworks which make web-based server app development a difficult task and, as a result, can only be used by professional software developers. Usually they require the use of many software development tools to be loaded on a computer for such development. Once development is complete, the app is tested on an MID.

Simple software languages such as scripting languages (e.g., Perl, Shell Script, MLE, and the like) can be created with simple text editors and are interpreted and are much easier to learn, use and deploy. However, such languages are not available for use in an MID for a web-based server app, referred to herein as “Problem 1”.

Another problem, referred to herein as “Problem 2”, with an MID for a web-based server app is that if the user creates a script using a text editor app, the only way for an MID-based web server to access such script would be for the programmer to place that script file on a common area of the MID, such as a MicroSD card. But MID operating systems (such as Android) do not allow code to be executed from a MicroSD Card. Normally, in operating systems, other than Android, a script is a text file where the first line indicates which interpreter is to be used to interpret the script, and the file attributes of the file that contain the script should indicate that the file is “executable”.

A third problem, referred to herein as “Problem 3”, with an MID for a web-based server app is that such interpreted scripting languages do not offer access to the rich functionality of an MID; they only offer the normal functionality that a server environment would offer. For example, the ability to send and receive Short Message Service (“SMS”) messages (aka text messages), notifications, send/receive emails, start calls, and the like, are only available to programs that run in the User Interface Framework that runs on top of the MID operating system. For example, the Android Operating System is commonly referred to as an operating system; but in reality, Android is a framework that runs on top of Linux®, which is an operating system that has existed since the early 1990's. In this example, the rich mobile functionality of Android is not available to programs that run at the level of Linux®. That functionality is only available to programs running at the Framework level.

In view of the foregoing, there is a need for a system and method to resolve the above three problems with MIDs for a web-based server app.

### SUMMARY

The present invention, accordingly, provides a Mobile Internet Device (“MID”) having an operating system and a framework. The operating system includes a first web server configured for use at the operating system level, wherein the first web server includes a script interpreter and is connectable to an Internet browser via the Internet for receiving requests from the browser. The framework includes a second web server configured to operate at the framework level and adapted for communication with the first web server, wherein the second web server further includes methods dedicated to encapsulating framework functions.

The MID preferably also includes a memory, such as a memory card, such as a MicroSD card or the like, having stored therein a script file.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and the specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims.

### BRIEF DESCRIPTION OF THE DRAWING

For a more complete understanding of the present invention, and the advantages thereof, reference is now made to the following descriptions taken in conjunction with the accompanying drawing, in which:

FIG. 1 is a schematic exemplifying a Mobile Internet Device (MID) embodying features of the present invention.

### DETAILED DESCRIPTION

Refer now to the drawing wherein depicted elements are, for the sake of clarity, not necessarily shown to scale and wherein like or similar elements are designated by the same reference numeral through the several views. In the interest of conciseness, well-known elements may be illustrated in schematic or block diagram form in order not to obscure the present invention in unnecessary detail, and details concerning various other components known to the art, such as web servers, frameworks, script interpreters, and the like necessary for the operation of many Mobile Internet Devices (“MIDs”), have not been shown or discussed in detail inasmuch as such details are not considered necessary to obtain a complete understanding of the present invention, and are considered to be within the skills of persons of ordinary skill in the relevant art. Additionally, as used herein, the term “substantially” is to be construed as a term of approximation.

It is noted that, unless indicated otherwise, all functions described herein may be performed by a processor such as a microprocessor, a controller, a microcontroller, an application-specific integrated circuit (ASIC), an electronic data processor, a computer, or the like, in accordance with code, such as program code, software, integrated circuits, and/or the like that are coded to perform such functions. Furthermore, it is considered that the design, development, and implementation details of all such code would be apparent to a person having ordinary skill in the art based upon a review of the present description of the invention.

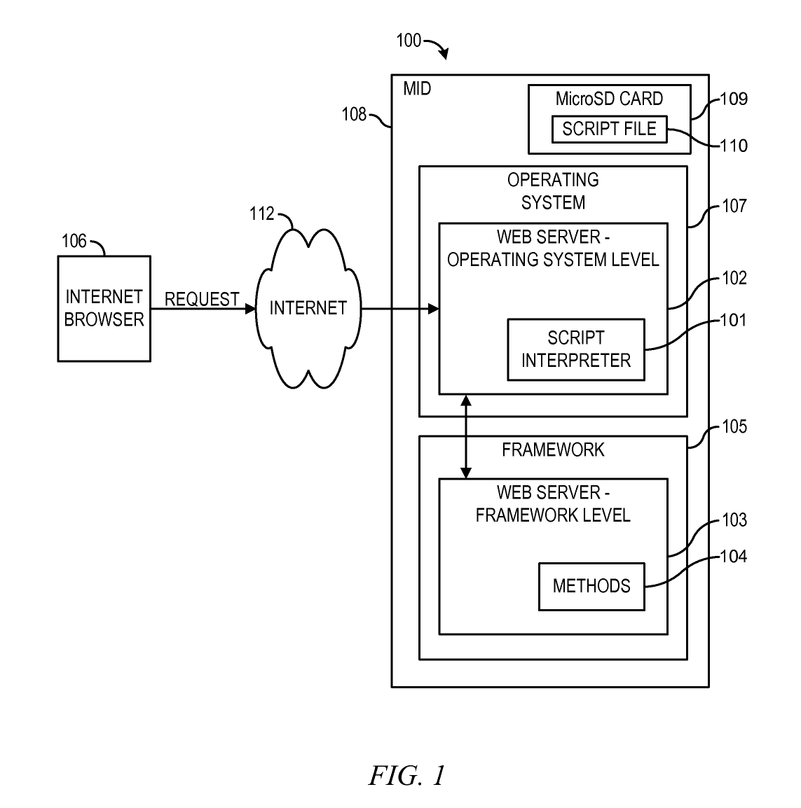

Referring to FIG. 1 of the drawing, the reference numeral 100 generally designates a system 100 having a Mobile Internet Device (“MID”) 108 embodying features of the present invention. The MID 108 includes an operating system 107 and framework 105. The operating system 107 includes a web server 102 configured for use at the operating system level. The web server 102 further includes a script interpreter 101. The web server 102 is coupled to an Internet browser 106 via the Internet 112 for receiving requests from the browser. The framework 105 includes a web server 103 configured to operate at the framework level and is adapted for communication with the web server 102 configured for use at the operating system level. The web server 103 further includes a methods 104 dedicated to encapsulating framework functions. Still further, the MID preferably includes a MicroSD card 109 having stored therein a script file 110.

Problem 1, discussed above in the Background, can be resolved by porting some scripting language to run on MID 108 devices. An existing scripting language is ported to run on an MID. By way of example, the scripting language depicted in patent application Ser. No. 09/888,329 is ported to an Android.

Problem 2, discussed above in the Background, may be solved by not relying on the operating system 107 to launch the interpreter 101 that will run the script. In one embodiment, this may be accomplished by having the web server 102 that is running at the operating system level 107 be compiled together with the interpreter 101, or at least be able to dynamically load the interpreter 101 into its own addressing space. Once that is done, the interpreter 101 can then open the text file that contains the script 110 and that is residing on the MicroSD card 109 just for reading, then interpret and execute the script in that file. To do this, the web server 102 and the interpreter 101 must be compiled together, or, at a minimum, the web server 101 must be able to dynamically load the interpreter 101 into the address space of the webserver 101 to be able to circumvent a denial by the MID's operating system 107 to execute scripts from the MicroSD card 109.

Problem 3, discussed above in the Background, may be resolved by having methods 104 run on the web server 103 at the framework level 105 that encapsulate various functions that are unique to the MID 108. For example, when sending SMS and the like, each of the functions encapsulated in the MID 108 would then be methods that are callable from the interpreter 101 that are running at the level of the operating system 102. The interpreter 101 is preferably enhanced to include new commands that essentially describe (or call) MID functionality located at the level of the framework 105.

By way of example, a script could then have a new command such as “SENDSMS 818-555-6666. This is an SMS message being sent from a script that is running as a Web-Based Server App”.

Every time an end user at, for example, an Internet browser 106 accesses a web page located in the MID 108, the web server 102 invokes the script interpreter 101 to execute the above script 110. The interpreter 101 opens the file containing the script 110, that was located in the MicroSD card 109, and executes the script 110. As a result of executing the script, the interpreter 101 calls methods 104 located in the web server 103 at the level of the frame work 105. The methods 104 calls the framework 105 to send the SMS message.

In the above example, every time the browser 106 attempts to access remotely the script 110 located on the MID 108 with a web server 102, an SMS message is sent to the phone number 818-555-6666.

One benefit of the invention is that less skilled programmers may write web-based applications that run on an MID and access the rich mobile framework functionality, such as SMS, and the like. Another benefit is that such a web-based server app may be developed directly in the phone, using a text editor app or the equivalent.

It is understood that the present invention may take many forms and embodiments. Accordingly, several variations may be made in the foregoing without departing from the spirit or the scope of the invention. For example, other kinds of servers (e.g., FTP servers) may be utilized instead of Web servers; private networks may be utilized instead of the Internet; other means (e.g., emulated storage, flash memory, or the like) may be utilized rather than a MicroSD card to store scripts.

Having thus described the present invention by reference to certain of its preferred embodiments, it is noted that the embodiments disclosed are illustrative rather than limiting in nature and that a wide range of variations, modifications, changes, and substitutions are contemplated in the foregoing disclosure and, in some instances, some features of the present invention may be employed without a corresponding use of the other features. Many such variations and modifications may be considered obvious and desirable by those skilled in the art based upon a review of the foregoing description of preferred embodiments.

1. A Mobile Internet Device (“MID”) comprising:
an operating system having a first web server configured for use at the operating system level, wherein the first web server includes a script interpreter and is connectable to an Internet browser via the Internet for receiving requests from the browser; and
a framework including a second web server configured to operate at the framework level and adapted for communication with the first web server, wherein the second web server further includes methods dedicated to encapsulating framework functions.

2. The MID of claim 1, further comprising a memory card having stored therein a script file.

3. The MID of claim 1, further comprising a MicroSD card having stored therein a script file.
